(19) United States
(12) Patent Application Publication
(10) Pub. No.: US 2026/0062309 A1
(43) Pub. Date: Mar. 5, 2026

(54) VANADIUM OXIDE AND BATTERY USING SAME

(71) Applicant: Panasonic Intellectual Property Management Co., Ltd., Osaka (JP)

(72) Inventors: Yoshiaki TANAKA, Kyoto (JP); Kaori SHINODA, Osaka (JP); Akihiro SAKAI, Nara (JP)

(21) Appl. No.: 19/383,882

(22) Filed: Nov. 10, 2025

Related U.S. Application Data
(63) Continuation of application No. PCT/JP2024/011303, filed on Mar. 22, 2024.

(30) Foreign Application Priority Data
May 22, 2023 (JP) 2023-084069

(51) Int. Cl. C01G 49/00; H01M 4/48; H01M 10/052

(52) U.S. Cl. CPC C01G 49/0027; H01M 4/48; H01M 10/052; C01P 2002/50; C01P 2006/40

(57) ABSTRACT

A vanadium oxide of the present disclosure is represented by a composition formula (1) Li_{(3+x+α-y)}Fe_{y}V₍₁₋ₓ₎MₓO_{(4+(α/2)+y)}. In the composition formula (1), 0≤a<1.0, 0≤x<1.0, and 0<y<0.7 are satisfied and M is at least one element selected from the group consisting of a tetravalent metal element and a tetravalent metalloid element. A battery of the present disclosure includes: a positive electrode; a negative electrode; and an electrolyte layer disposed between the positive electrode and the negative electrode. The negative electrode includes the vanadium oxide of the present disclosure.

This application is a continuation of PCT/JP2024/011303 filed on Mar. 22, 2024, which claims foreign priority of Japanese Patent Application No. 2023-084069 filed on May 22, 2023, the entire contents of both of which are incorporated herein by reference.

### BACKGROUND OF THE INVENTION

### 1. Field of the Invention

The present invention relates to a vanadium oxide composite and a battery including the same.

### 2. Description of Related Art

Since having a low reaction potential and a high capacity, Li₃VO₄ has attracted attention as a next-generation negative electrode active material. JP 2008-077847 A discloses a non-aqueous secondary battery including Li₃VO₄ as a negative electrode active material.

WO 2019/044902 A1 discloses a co-fired all-solid-state battery including a negative electrode active material represented by (Li_{[3-ax+(5-b)y]}Aₓ)(V_{1-y}B_{y})O₄. In the formula, A is at least one element selected from the group consisting of Mg, Al, Ga, and Zn, and B is at least one element selected from the group consisting of Zn, Al, Ga, Si, Ge, P, and Ti. The values x and y satisfy 0≤x≤1.0 and 0≤y≤0.6, respectively. The symbol a represents the average valence of A, while b represents the average valence of B.

### SUMMARY OF THE INVENTION

The present disclosure provides a new vanadium oxide that can be used as a battery material.

The present disclosure provides a vanadium oxide represented by a composition formula (1) Li_{(3+x+α-y)}Fe_{y}V₍₁₋ₓ₎MₓO_{(4+(α/2)+y)}, where 0≤α<1.0, 0≤x<1.0, and 0<y<0.7 are satisfied and M is at least one element selected from the group consisting of a tetravalent metal element and a tetravalent metalloid element.

The present disclosure provides a new vanadium oxide that can be used as a battery material.

### BRIEF DESCRIPTION OF THE DRAWINGS

FIG. 1 is a cross-sectional view showing a battery 1000 according to a second embodiment.

FIG. 2 is a cross-sectional view showing a battery 1001 according to a modification.

FIG. 3 is a cross-sectional view showing an electrode material 1100 according to the second embodiment.

FIG. 4 is a graph showing initial discharge characteristics of a battery of Sample 1.

### DETAILED DESCRIPTION

Embodiments of the present disclosure will be described hereinafter with reference to the drawings. The present disclosure is not limited to the embodiments below.

### First Embodiment

A vanadium oxide according to a first embodiment is represented by the following composition formula (1). In the composition formula (1), 0≤α<1.0, 0≤x<1.0, and 0<y<0.7 are satisfied, and M is at least one element selected from the group consisting of a tetravalent metal element and a tetravalent metalloid element.

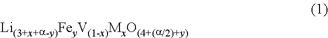

The vanadium oxide according to the first embodiment can be used as a battery material. The vanadium oxide according to the first embodiment can be used, for example, as a negative electrode active material. The vanadium oxide according to the first embodiment can be used, for example, to obtain a battery having excellent charge and discharge characteristics. The vanadium oxide according to the first embodiment is suitable, for example, for increasing the battery capacity. The battery is, for example, a solid-state battery. The solid-state battery may be a primary battery or a secondary battery.

For example, a battery including the vanadium oxide according to the first embodiment has an increased capacity because 0<y<0.7 is satisfied in the composition formula (1). This is because Fe doping enhances the electron conductivity of the vanadium oxide, facilitating insertion of Li into and extraction of Li from the vanadium oxide.

Fe and O in amounts expressed with y in the composition formula (1) may be inside a particle of the vanadium oxide, or may be present outside the particle as a second phase different from a first phase forming the particle.

In the composition formula (1), 0.183≤y≤0.61 may be satisfied. In this case, the vanadium oxide according to the first embodiment can increase the battery capacity.

The upper limit and the lower limit of the range of y in the composition formula (1) may be any pair of numerical values selected from more than 0.0 (0<y), 0.092, 0.183, 0.244, 0.366, 0.610, and less than 0.7 (y<0.7).

For example, a battery including the vanadium oxide according to the first embodiment has an increased capacity also because 0≤α<1.0 is satisfied in the composition formula (1). This is because insertion of Li into and extraction of Li from the vanadium oxide according to the first embodiment are facilitated.

In the composition formula (1), 0<α<1.0 may be satisfied. That is, the vanadium oxide according to the first embodiment may include Li and O in amounts exceeding those derived from stoichiometric composition. In this case, the vanadium oxide according to the first embodiment can increase the battery capacity. This is because the excess Li and O enhance the electron conductivity of the vanadium oxide, facilitating insertion of Li into and extraction of Li from the vanadium oxide according to the first embodiment. The stoichiometric composition means composition where a molar ratio between the elements forming the vanadium oxide is expressed by integral multiples. For example, Li₃VO₄ has stoichiometric composition.

Li and O in amounts expressed with a in the composition formula (1) may be inside the particle of the vanadium oxide, or may be present outside the particle as a second phase different from a first phase forming the particle. It should be noted that each of the vanadium oxides disclosed in JP 2008-077847 A and WO 2019/044902 A1 does not include Li and O in amounts comparable to those expressed with a.

In the composition formula (1), 0≤α<0.85 may be satisfied, or 0<α<0.85 may be satisfied. In this case, the vanadium oxide according to the first embodiment can increase the battery capacity.

In the composition formula (1), 0.2≤α≤0.6 may be satisfied. In this case, the vanadium oxide according to the first embodiment can increase the battery capacity.

The upper limit and the lower limit of the range of α in the composition formula (1) may be any pair of numerical values selected from 0 or more (0≤α), more than 0 (0<α), 0.171, 0.219, 0.258, 0.277, 0.287, 0.301, 0.316, 0.589, 0.85, and less than 1.0 (α<1.0).

In the composition formula (1), 0<x<1.0 may be satisfied. In this case, the vanadium oxide according to the first embodiment can increase the battery capacity. This is presumably because the electron conductivity of the vanadium oxide is enhanced by replacing one or some of vanadium ions with ion(s) of the metal M.

In the composition formula (1), 0<x≤0.1 may be satisfied. In this case, the vanadium oxide according to the first embodiment can increase the battery capacity. The symbol x may be 0.04 or more and 0.06 or less, or may be 0.05.

When x satisfies the above inequality in the composition formula (1), insertion of Li into and extraction of Li from the vanadium oxide according to the first embodiment is further facilitated. Therefore, as described above, the vanadium oxide according to the first embodiment can increase the battery capacity.

As described above, M is at least one element selected from the group consisting of the tetravalent metal element and the tetravalent metalloid element. Examples of the tetravalent metal element and the tetravalent metalloid element include Ti, Zr, Si, Ge, and Sn. When the pentavalent V element is substituted by the tetravalent metal element and/or the tetravalent metalloid element, a hole and/or a Li ion becomes a charge carrier. This further facilitates insertion of Li into and extraction of Li from the vanadium oxide.

In the composition formula (1), M may include Ti. In this case, the vanadium oxide according to the first embodiment can increase the battery capacity. The symbol M may be Ti.

The vanadium oxide according to the first embodiment may have a β-crystalline phase, a γ-crystalline phase, or both of these crystalline phases. The vanadium oxide according to the first embodiment may have only a β-crystalline phase.

The shape of the vanadium oxide according to the first embodiment is not limited. The shape thereof is, for example, an acicular, spherical, or ellipsoidal shape. The vanadium oxide according to the first embodiment may have a particle shape. The vanadium oxide according to the first embodiment may be formed in the shape of a pellet or a plate.

In the case where the vanadium oxide according to the first embodiment has a particle (e.g. spherical) shape, the particles of the vanadium oxide may have a median diameter of 0.1 μm or more and 100 μm or less, or a median diameter of 0.5 μm or more and 10 μm or less. In this case, the vanadium oxide according to the first embodiment and another material can be favorably dispersed. The other material is, for example, a solid electrolyte.

The median diameter of particles means the particle size (d50) corresponding to 50% of a cumulative volume in a volumetric particle size distribution. The volumetric particle size distribution can be measured by a laser diffraction measurement device or an image analysis device.

### <Method for Manufacturing Vanadium Oxide>

The vanadium oxide according to the first embodiment can be manufactured by the following method.

Raw material powders are prepared so that target composition will be achieved. Examples of the raw material powders include an oxide, a hydroxide, a carbonate, a nitrate, and an organic salt.

As one example, it is assumed that, in the vanadium oxide represented by the composition formula (1) Li_{(3+x+α-y)}Fe_{y}V₍₁₋ₓ₎MₓO_{(4+(α/2)+y)}, M is Ti and x, α, and Fe are, respectively, 0.05, 0, and 0.1 at mixing the raw materials. Then, Li₂CO₃, V₂O₅, TiO₂, and FeO are mixed at a molar ratio of Li₂CO₃:V₂O₅:TiO₂:FeO=(2.95/2):(0.95/2):0.05:0.1.

In the case of α≠0, a substance serving as a Li source, such as Li₂CO₃, may be further added taking the value of α in target composition into account, followed by mixing the raw material powders. An excess of the Li source to be mixed in excess can be determined as appropriate according to, for example, the value of α in the target composition and the substance used as the Li source. In one example, to manufacture the vanadium oxide satisfying 0<x<1.0 and 0<α<1.0, the Li source may be used, for example, in a 0.5 mass % to 40 mass % excess or a 1 mass % to 30 mass % excess of a Li source amount determined in accordance with a molar ratio determined assuming that α is 0.

A lithium hydroxide or its hydrate may be used instead of Li₂CO₃.

The mixture of the raw material powders is fired to give a reaction product. An atmosphere in which the firing is performed may be atmospheric air or an inert gas atmosphere. The inert atmosphere is, for example, an argon atmosphere or a nitrogen atmosphere.

Alternatively, a reaction product may be obtained by causing a reaction of the mixture of the raw material powders in a mixer, such as a planetary ball mill, mechanochemically (by mechanochemical milling).

The vanadium oxide according to the first embodiment is obtained by these methods.

The molar ratio at the time of mixing the raw materials and the molar ratio in the reaction product are not necessarily equal to each other. This is because the raw materials may not be taken into the reaction product during the reaction because of evaporation.

The composition of the vanadium oxide is determined by quantitative analysis. Li is quantified by atomic absorption spectroscopy. V, Fe, and M are quantified by high-frequency inductively-coupled plasma (ICP) emission spectrometry. The value of x in the composition formula (1) can be determined from an amount of the element M in the vanadium oxide. The value of y in the composition formula (1) can be determined from an amount of Fe in the vanadium oxide. The value of a in the composition formula (1) can be determined from the amount of Li, the amount of Fe, and the amount of the element M in the vanadium oxide.

### Second Embodiment

A second embodiment will be described hereinafter. The features described in the first embodiment are omitted as appropriate.

A battery according to the second embodiment includes a positive electrode, an electrolyte layer, and a negative electrode. The electrolyte layer is disposed between the positive electrode and the negative electrode. The negative electrode includes the vanadium oxide according to the first embodiment.

The battery according to the second embodiment has excellent charge and discharge characteristics.

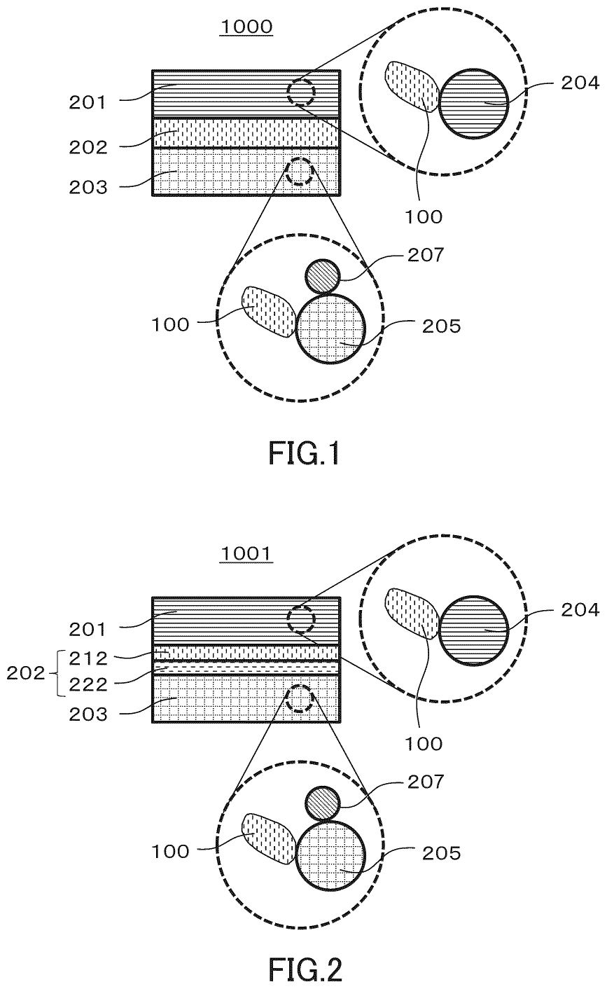

FIG. 1 is a cross-sectional view showing a battery 1000 according to the second embodiment.

The battery 1000 includes a positive electrode 201, an electrolyte layer 202, and a negative electrode 203. The electrolyte layer 202 is disposed between the positive electrode 201 and the negative electrode 203.

The positive electrode 201 includes positive electrode active material particles 204 and solid electrolyte particles 100.

The electrolyte layer 202 includes an electrolyte material. The electrolyte material is, for example, a solid electrolyte material.

The negative electrode 203 includes negative electrode active material particles 205 and the solid electrolyte particles 100.

The negative electrode active material particle 205 is a particle including the vanadium oxide according to the first embodiment. The negative electrode active material particle 205 may be a particle including the vanadium oxide according to the first embodiment as its principal component. The particle including the vanadium oxide according to the first embodiment as its principal component refers to a particle in which the component having the highest mass content is the vanadium oxide according to the first embodiment. The negative electrode active material particle 205 may be a particle consisting of the vanadium oxide according to the first embodiment. The negative electrode active material particle 205 has, for example, a spherical shape.

The negative electrode active material particles 205 may have a median diameter of 0.1 μm or more and 100 μm or less. In the case where the negative electrode active material particles 205 have a median diameter of 0.1 μm or more, the negative electrode active material particles 205 and the solid electrolyte particles 100 can be favorably dispersed in the negative electrode 203. This improves the charge and discharge characteristics of the battery. In the case where the negative electrode active material particles 205 have a median diameter of 100 μm or less, the diffusion rate of lithium in the negative electrode active material particles 205 improves. This can allow the battery 1000 to operate at high power.

The negative electrode active material particles 205 may have a median diameter larger than that of the solid electrolyte particles 100. This can allow favorable dispersion of the negative electrode active material particles 205 and the solid electrolyte particles 100.

In order to increase an energy density and power output of the battery 1000, a ratio of the volume of the negative electrode active material particles 205 to the sum of the volume of the negative electrode active material particles 205 and the volume of the solid electrolyte particles 100 may be 0.30 or more and 0.95 or less in the negative electrode 203.

In order to increase the energy density and power output of the battery 1000, the negative electrode 203 may have a thickness of 10 μm or more and 500 μm or less.

The solid electrolyte particle 100 included in the negative electrode 203 may be a sulfide solid electrolyte, a halide solid electrolyte, an oxide solid electrolyte, or a polymer solid electrolyte.

In the present disclosure, the term “sulfide solid electrolyte” means a solid electrolyte containing sulfur. The term “oxide solid electrolyte” means a solid electrolyte containing oxygen. The oxide solid electrolyte may contain an anion (excluding a sulfur anion and a halogen anion) other than oxygen. The term “halide solid electrolyte” means a solid electrolyte containing a halogen element and being free of sulfur. The halide solid electrolyte may contain not only the halogen element but also oxygen.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

Examples of the halide solid electrolyte include compounds represented by LiₐMe_{b}Y_{c}X₆. In the formula, the following equality and inequality are satisfied: a+mb+3c=6; and c>0. The symbol Me is at least one element selected from the group consisting of metal elements other than Li and Y and metalloid elements. The symbol X is at least one selected from the group consisting of F, Cl, Br, and I. The value of m represents the valence of Me.

The metalloid elements are B, Si, Ge, As, Sb, and Te. The metal elements are all the elements (except H) included in Groups 1 to 12 of the periodic table and all the elements (except B, Si, Ge, As, Sb, Te, C, N, P, O, S, and Se) included in Groups 13 to 16 of the periodic table.

In order to increase the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

Ather example of the halide solid electrolyte is a compound represented by Li_{α′}Me′_{β}O_{γ}X_{δ}. In the formula, α′, β, γ, and δ are each greater than 0, Me′ is at least one element selected from the group consisting of metalloid elements and metal elements other than Li, X is at least one selected from the group consisting of Cl, Br, and I, and the following mathematical inequalities and equality are satisfied: 0.9≤α′≤1.2; β=1.0; 1.0≤γ≤1.3; and 3.6≤δ≤4.0.

Examples of the oxide solid electrolyte include:
(i) NASICON solid electrolytes, such as LiTi₂(PO₄)₃ and element-substituted substances thereof;
(ii) perovskite solid electrolytes, such as (LaLi)TiO₃;
(iii) LISICON solid electrolytes, such as Li₁₄ZnGe₄O₁₆, Li₄SiO₄, LiGeO₄, and element-substituted substances thereof;
(iv) garnet solid electrolytes, such as Li₇La₃Zr₂O₁₂ and element-substituted substances thereof; and
(v) Li₃PO₄ and N-substituted substances thereof.

Examples of the polymer solid electrolyte include a compound of a polymer compound and a lithium salt. The polymer compound may have an ethylene oxide structure. The polymer compound having an ethylene oxide structure can contain a large amount of lithium salt, and thus has higher ionic conductivity. The polymer solid electrolyte may be, for example, a composite compound of polyethylene oxide and a lithium salt. Such a polymer solid electrolyte is, for example, lithium bis(trifluoromethanesulfonyl)imide.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

The positive electrode 201 incudes a material capable of intercalating and deintercalating metal ions, such as lithium ions. The positive electrode 201 includes, for example, a positive electrode active material (for example, the positive electrode active material particles 204).

Examples of the positive electrode active material include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni, Co, Al)O₂, Li(Ni, Co, Mn)O₂, and LiCoO₂.

In the present disclosure, the expression “(A, B, C)” represents “at least one selected from the group consisting of A, B, and C”.

Lithium phosphate or a lithium-containing transition metal phosphate may be used as the positive electrode active material from the viewpoint of cost and safety of the battery 1000.

The positive electrode active material particles 204 may have a median diameter of 0.1 μm or more and 100 μm or less. In the case where the positive electrode active material particles 204 have a median diameter of 0.1 μm or more, the positive electrode active material particles 204 and the solid electrolyte particles 100 can be favorably dispersed in the positive electrode 201. This improves the charge and discharge characteristics of the battery. In the case where the positive electrode active material particles 204 have a median diameter of 100 μm or less, the diffusion rate of lithium in the positive electrode active material particles 204 improves. This can allow the battery 1000 to operate at high power.

The positive electrode active material particles 204 may have a median diameter larger than that of the solid electrolyte particles 100. This can allow favorable dispersion of the positive electrode active material particles 204 and the solid electrolyte particles 100.

In order to increase the energy density and power output of the battery 1000, a ratio of the volume of the positive electrode active material particles 204 to the sum of the volume of the positive electrode active material particles 204 and the volume of the solid electrolyte particles 100 may be 0.30 or more and 0.95 or less in the positive electrode 201.

To prevent the positive electrode active material particle 204 from reacting with the solid electrolyte particle 100, a coating layer may be formed on a surface of the positive electrode active material particle 204. In this case, an increase of a reaction overvoltage of the battery can be suppressed. Examples of a coating material included in the coating layer include solid electrolytes, such as a sulfide solid electrolyte, an oxide solid electrolyte, a polymer solid electrolyte, and a halide solid electrolyte.

The coating material may be a halide solid electrolyte or an oxide solid electrolyte. The halide solid electrolyte may include F. This improves stability of the coating material at a high potential. Therefore, the battery 1000 has high charge and discharge efficiency. The oxide solid electrolyte may be lithium niobate or a polyanion material which has excellent stability even at a high potential. In this case, the battery 1000 has high charge and discharge efficiency.

In order to increase the energy density and power output of the battery 1000, the positive electrode 201 may have a thickness of 10 μm or more and 500 μm or less.

The solid electrolyte particle 100 included in the positive electrode 201 may be a solid electrolyte, such as a sulfide solid electrolyte, a halide solid electrolyte, an oxide solid electrolyte, a polymer solid electrolyte, or an organic polymer solid electrolyte.

The electrolyte layer 202 includes an electrolyte material. The electrolyte material is, for example, a solid electrolyte material. The electrolyte layer 202 may be a solid electrolyte layer. The solid electrolyte material included in the electrolyte layer 202 may be a sulfide solid electrolyte, a halide solid electrolyte, or a polymer solid electrolyte.

The electrolyte layer 202 may have a thickness of 1 μm or more and 100 μm or less. In the case where the electrolyte layer 202 has a thickness of 1 μm or more, short-circuiting between the positive electrode 201 and the negative electrode 203 is less likely to occur. In the case where the electrolyte layer 202 has a thickness of 100 μm or less, the battery 1000 can operate at high power.

In order to facilitate transfer of lithium ions and improve the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution contains a nonaqueous solvent and a lithium salt dissolved in the nonaqueous solvent. Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a mixture of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used. The concentration of the lithium salt is, for example, 0.5 mol/liter or more and 2 mol/liter or less.

As the gel electrolyte, a polymer material impregnated with a nonaqueous electrolyte solution can be used. Examples of the polymer material include polyethylene oxide, polyacrylonitrile, polyvinylidene fluoride, polymethyl methacrylate, and a polymer having an ethylene oxide bond.

Examples of cations contained in the ionic liquid include:
(i) aliphatic linear quaternary salts, such as tetraalkylammoniums and tetraalkylphosphoniums;
(ii) aliphatic cyclic ammoniums, such as pyrrolidiniums, morpholiniums, imidazoliniums, tetrahydropyrimidiniums, piperaziniums, and piperidiniums; and
(iii) nitrogen-containing heterocyclic aromatic cations, such as pyridiniums and imidazoliums.

Examples of anions contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

In order to increase adhesion between the particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer may also be used as the binder. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above-described materials may be used as the binder.

At least one selected from the positive electrode 201 and the negative electrode 203 may include a conductive additive in order to increase electronic conductivity.

Examples of the conductive additive include:
(i) graphite, such as natural graphite or artificial graphite;
(ii) carbon black, such as acetylene black or ketjen black;
(iii) conductive fiber, such as carbon fiber or metal fiber;
(iv) fluorinated carbon;
(v) metal powder, such as aluminum powder;
(vi) conductive whiskers, such as a zinc oxide whisker or a potassium titanate whisker;
(vii) conductive metal oxides, such as titanium oxide; and
(viii) conductive polymer compounds, such as a polyaniline compound, a polypyrrole compound, and a polythiophene compound.

For cost reduction, the conductive additive of (i) or (ii) above may be used.

The negative electrode 203 may include a conductive additive 207 as well as the negative electrode active material particles 205. Examples of the material of the conductive additive 207 are as described above.

The conductive additive 207 may at least partially coat a surface of the negative electrode active material particle 205. In this case, the contact area between the conductive additive 207 and the negative electrode active material particle 205 increases. This can result in decrease in the battery resistance and increase in the power output.

A ratio of the volume of the conductive additive 207 to the sum of the volume of the negative electrode active material particles 205 and the volume of the conductive additive 207 may be 0.01 or more and 0.4 or less in the negative electrode 203.

FIG. 2 is a cross-sectional view showing a battery 1001 of a modification. As shown in FIG. 2, another electrolyte layer (i.e., a second electrolyte layer) may be further provided between the electrolyte layer 202 and the negative electrode 203. When the electrolyte layer 202 is formed of a first electrolyte layer 212 and a second electrolyte layer 222, the second electrolyte layer 222 may be formed of another solid electrolyte material that is electrochemically more stable than the first electrolyte layer 212. Specifically, a reduction potential of the solid electrolyte material forming the second electrolyte layer 222 may be lower than a reduction potential of the solid electrolyte material forming the first electrolyte layer 212. In this case, the solid electrolyte material included in the first electrolyte layer 212 can be used without being reduced. Consequently, the charge and discharge efficiency of the battery 1001 can be enhanced.

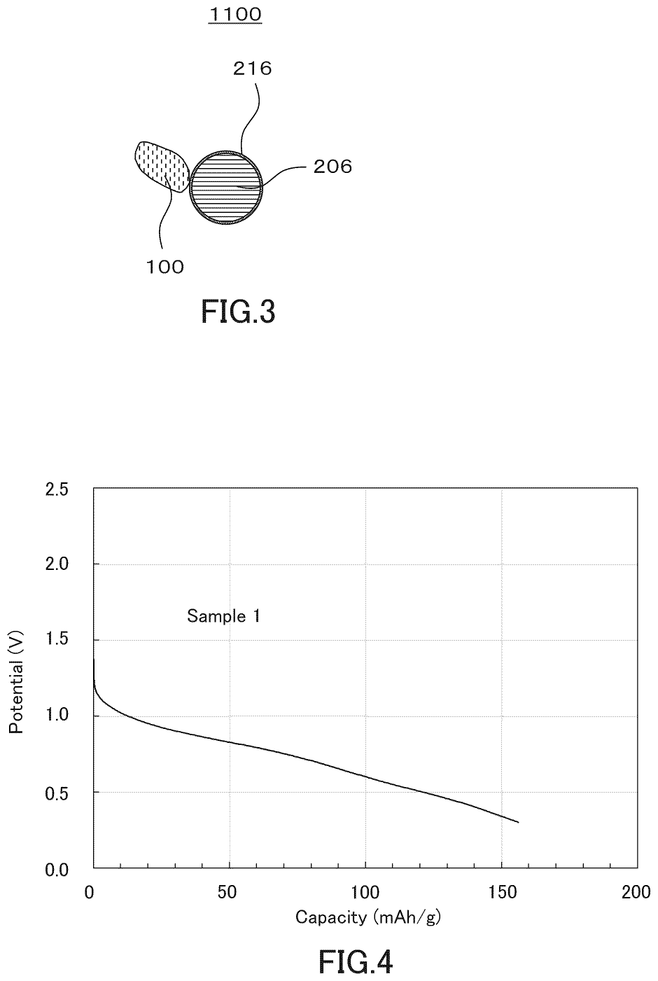

FIG. 3 is a cross-sectional view showing an electrode material 1100 according to the second embodiment. The electrode material 1100 shown in FIG. 3 may be included in the negative electrode 203. To prevent the solid electrolyte particle 100 from reacting with a negative electrode active material (namely, an electrode active material particle 206), a coating layer 216 may be formed on the surface of the electrode active material particle 206. Consequently, the battery has high charge and discharge efficiency. That is, the vanadium oxide according to the first embodiment included in the negative electrode 203 may be coated with a coating material.

Examples of the coating material included in the coating layer 216 include a sulfide solid electrolyte, an oxide solid electrolyte, a polymer solid electrolyte, and a halide solid electrolyte.

Examples of the sulfide solid electrolyte include Li₂S—P₂S₅. Examples of the oxide solid electrolyte include trilithium phosphate. Examples of the polymer solid electrolyte include a composite compound of polyethylene oxide and a lithium salt. Examples of such a polymer solid electrolyte include lithium bis(trifluoromethanesulfonyl)imide.

Examples of the shape of the battery according to the second embodiment include coin type, cylindrical type, prismatic type, sheet type, button type, flat type, and stack type shapes.

The battery according to the second embodiment may be manufactured, for example, by preparing materials for forming a positive electrode, an electrolyte layer, and a negative electrode and then producing, by a known method, a stacked body in which the positive electrode, the electrolyte layer, and the negative electrode are disposed in this order.

### OTHER EMBODIMENTS

### (Supplement)

According to the description of the above embodiments, the following techniques are disclosed.

### (Technique 1)

A vanadium oxide represented by a composition formula (1) Li_{(3+x+α-y)}Fe_{y}V₍₁₋ₓ₎MₓO_{(4+(α/2)+y)}, where 0≤α<1.0, 0≤x<1.0, and 0<y<0.7 are satisfied and M is at least one element selected from the group consisting of a tetravalent metal element and a tetravalent metalloid element.

The vanadium oxide according to Technique 1 is a new substance that can be used as a battery material. The vanadium oxide according to Technique 1 can be used, for example, as a negative electrode active material. The vanadium oxide according to Technique 1 is suitable, for example, for increasing the charge and discharge characteristics of a battery, and is suitable, for example, for increasing the battery capacity.

### (Technique 2)

The vanadium oxide according to Technique 1, wherein the M includes Ti in the composition formula (1).

### (Technique 3)

The vanadium oxide according to Technique 1 or 2, wherein 0≤α<0.85 is satisfied in the composition formula (1).

### (Technique 4)

The vanadium oxide according to Technique 1 or 2, wherein 0<α<1.0 is satisfied in the composition formula (1).

### (Technique 5)

The vanadium oxide according to Technique 1 or 2, wherein 0.2≤α≤0.6 is satisfied in the composition formula (1).

### (Technique 6)

The vanadium oxide according to any one of Techniques 1 to 5, wherein 0<x<1.0 is satisfied in the composition formula (1).

### (Technique 7)

The vanadium oxide according to any one of Techniques 1 to 5, wherein 0<x≤0.1 is satisfied in the composition formula (1).

### (Technique 8)

The vanadium oxide according to any one of Techniques 1 to 7, wherein 0.183≤y≤0.61 is satisfied in the composition formula (1).

The vanadium oxides according to Techniques 2 to 8 are more suitable for increasing the battery capacity.

### (Technique 9)

A battery including:
a positive electrode;
a negative electrode; and
an electrolyte layer disposed between the positive electrode and the negative electrode, wherein
the negative electrode includes the vanadium oxide according to any one of Techniques 1 to 8.

The battery according to Technique 9 has excellent charge and discharge characteristics.

### (Technique 10)

The battery according to Technique 9, wherein the negative electrode further includes a conductive additive. The battery according to Technique 10 can increase the electron conductivity of the negative electrode. Hence, the battery according to Technique 9 has more excellent charge and discharge characteristics.

### EXAMPLES

Hereinafter, the present disclosure will be described in more details. A vanadium oxide of each sample can be represented by the composition formula (1) Li_{(3+x+α-y)}Fe_{y}V₍₁₋ₓ₎MₓO_{(4+(α/2)+y)}.

### <<Sample 1>>

### [Production of Vanadium Oxide]

Li₂CO₃ (manufactured by Kojundo Chemical Laboratory Co., Ltd.; purity: 99.9%), V₂O₅ (manufactured by Kojundo Chemical Laboratory Co., Ltd.; purity: 99.9%), TiO₂ (manufactured by KOJUNDO CHEMICAL LABORATORY CO., LTD.; purity: 99.9%), and FeO (manufactured by Kojundo Chemical Laboratory Co., Ltd.; purity: 99.9%) were prepared as raw material powders at a molar ratio of Li₂CO₃:V₂O₅:TiO₂:FeO=1.525:0.475:0.05:0.092. Additionally, the above Li₂CO₃ was prepared in a 10 wt % excess of the above composition. The raw material powders were mixed in a mortar to give a powder mixture. The obtained powder mixture was provisionally fired in air at 600° C. for three hours. The provisionally fired powder was subjected to main firing in air at 920° C. for 15 hours. In both the provisional-firing and the main-firing, the temperature increase rate was 10° C. per minute, and the temperature decrease rate was 5° C. per minute. Thus, a vanadium oxide of Sample 1 was obtained.

For the vanadium oxide of Sample 1, x, y, and a in the composition formula (1) were respectively 0.05, 0.092, and 0.301.

The values x and y were determined by analyzing amounts of Ti and Fe with an ICP emission spectrometer (PS3520VDDII manufactured by Hitachi High-Tech Science Corporation). The value α was determined by analyzing an amount of Li with an atomic absorption spectrophotometer (Z-2300 manufactured by Hitachi High-Technologies Corporation) and using the result of the analysis and those for the amount of Ti (that is, the value of x) and the amount of Fe (that is, the value of y).

### [Production of Battery]

In an argon atmosphere with a dew point of −60° C. or lower, the vanadium oxide of Sample 1 and a solid electrolyte Li₃PS₄ were prepared such that the volume ratio between the vanadium oxide and the Li₃PS₄ was 60:40. Additionally, 5 parts by mass of acetylene black was prepared relative to 100 parts by mass of the vanadium oxide. These materials were mixed in an agate mortar. A negative electrode mixture was obtained in this manner.

In an insulating cylinder having an inner diameter of 9.5 mm, a solid electrolyte Li₃PS₄ (80 mg) and the negative electrode mixture (6.5 mg) were stacked to give a stacked body. A pressure of 360 MPa was applied to the stacked body to form a solid electrolyte layer and a negative electrode. The solid electrolyte layer had a thickness of 500 μm.

Next, Li (thickness: 300 μm) was stacked on the solid electrolyte layer. A pressure of 80 MPa was applied to the resulting stacked body to form a positive electrode.

Next, current collectors formed of stainless steel were attached to the positive electrode and the negative electrode, and a current collector lead was attached to each of the current collectors.

Finally, an insulating ferrule was used to isolate the interior of the insulating cylinder from the outside air atmosphere, thereby sealing the interior of the cylinder.

A battery of Sample 1 was obtained in the above manner. The battery of Sample 1 is a monopolar test cell in which the negative electrode is used as a working electrode and the positive electrode is used as a counter electrode, and such a cell is used for testing the performance of the negative electrode. Specifically, the negative electrode to be tested is used as a working electrode, and an appropriate active material in an amount sufficient for a reaction of the working electrode is used for a counter electrode. In the case of this test cell, which was for testing the performance of the negative electrode, metal Li was used as the counter electrode. A negative electrode whose performance was tested by using such a test cell can be included in a secondary battery, for example, in combination with a positive electrode including a positive electrode active material, such as a Li-containing transition metal oxide, as described in the above embodiments.

### [Charge-Discharge Test]

FIG. 4 is a graph showing initial discharge characteristics of the battery of Sample 1. The horizontal axis represents discharge capacity. The vertical axis represents voltage. The results shown in FIG. 4 were measured by the following method.

The following charge and discharge test was performed by using the battery of Sample 1. As described above, the battery produced in Sample 1 is a monopolar test cell, and corresponds to a negative electrode half cell. Therefore, in Sample 1, a direction in which the potential of the half cell decreases by insertion of Li ions into the negative electrode is called charging, and a direction in which the potential increases is called discharging. That is, charging in Sample 1 is substantially (i.e., in the case of a full cell) discharging, and discharging in Sample 1 is substantially charging.

The battery of Sample 1 was disposed in a thermostatic chamber maintained at 25° C.

The battery of Sample 1 was discharged at a current value corresponding to 1 C rate (1-hour rate) with respect to the theoretical capacity of the battery until the voltage reached 0.3 V. Next, the battery of Sample 1 was charged at a current value corresponding to 0.05 C rate until the voltage reached 2.5 V.

According to the results of the charge-discharge test, the battery of Sample 1 had an initial discharge capacity of 157 mAh/g.

### <<Samples 2 to 10>>

### [Production of Vanadium Oxide]

In Sample 2, Li₂CO₃, V₂O₅, TiO₂, and FeO were prepared at a molar ratio of Li₂CO₃:V₂O₅:TiO₂:FeO=1.434:0.475:0.05:0.183. The value x was 0.05, y was 0.183, and α was 0.287.

In Sample 3, Li₂CO₃, V₂O₅, TiO₂, and FeO were prepared at a molar ratio of Li₂CO₃:V₂O₅:TiO₂:FeO=1.403:0.475:0.05:0.244. The value x was 0.05, y was 0.244, and α was 0.277.

In Sample 4, Li₂CO₃, V₂O₅, TiO₂, and FeO were prepared at a molar ratio of Li₂CO₃:V₂O₅:TiO₂:FeO=1.342:0.475:0.05:0.366. The value x was 0.05, y was 0.366, and α was 0.258.

In Sample 5, Li₂CO₃, V₂O₅, TiO₂, and FeO were prepared at a molar ratio of Li₂CO₃:V₂O₅:TiO₂:FeO=1.220:0.475:0.05:0.610. The value x was 0.05, y was 0.610, and α was 0.219.

In Sample 6, Li₂CO₃, V₂O₅, TiO₂, and FeO were prepared at a molar ratio of Li₂CO₃:V₂O₅:TiO₂:FeO=1.434:0.475:0.05:0.183. In Sample 6, Li₂CO₃ was not added excessively. The value x was 0.05, y was 0.183, and α was 0.

In Sample 7, Li₂CO₃, V₂O₅, TiO₂, and FeO were prepared at a molar ratio of Li₂CO₃:V₂O₅:TiO₂:FeO=1.434:0.475:0.05:0.183. In Sample 7, Li₂CO₃ was prepared in a 20 wt % excess. The value x was 0.05, y was 0.183, and α was 0.589.

In Sample 8, Li₂CO₃, V₂O₅, TiO₂, and FeO were prepared at a molar ratio of Li₂CO₃:V₂O₅:TiO₂:FeO=1.434:0.475:0.05:0.183. In Sample 8, Li₂CO₃ was prepared in a 30 wt % excess. The value x was 0.05, y was 0.183, and α was 0.891.

In Sample 9, Li₂CO₃, V₂O₅, and TiO₂ were prepared at a molar ratio of Li₂CO₃:V₂O₅:TiO₂=1.525:0.475:0.05. The value x was 0.05, y was 0, and α was 0.316.

In Sample 10, Li₂CO₃, V₂O₅, TiO₂, and FeO were prepared at a molar ratio of Li₂CO₃:V₂O₅:TiO₂:FeO=1.068:0.475:0.05:0.915. The value x was 0.05, y was 0.920, and α was 0.171.

Vanadium oxides of Samples 2 to 10 were obtained in the same manner as for Sample 1 except for the above matters.

### [Charge-Discharge Test]

Batteries including the vanadium oxides of Samples 2 to 10 as negative electrodes were produced in the same manner as for Sample 1, and the initial discharge capacities thereof were measured in the same manner as for Sample 1. Table 1 shows the measurement results.

TABLE 1

| | | | | | Discharge |
|---|---|---|---|---|---|
| | Li_{(3+x+α-y)}Fe_{y}V₍₁₋ₓ₎MₓO_{(4+α/2+y)} | | | | capacity at |
| | M | x | y | α | 1 C (mAh/g) |
| Sample 1 | Ti | 0.05 | 0.092 | 0.301 | 157 |
| Sample 2 | | | 0.183 | 0.287 | 221 |
| Sample 3 | | | 0.244 | 0.277 | 186 |
| Sample 4 | | | 0.366 | 0.258 | 149 |
| Sample 5 | | | 0.610 | 0.219 | 226 |
| Sample 6 | | | 0.183 | 0 | 113 |
| Sample 7 | | | 0.183 | 0.589 | 221 |
| Sample 8 | | | 0.183 | 0.891 | 47 |
| Sample 9 | | | 0 | 0.316 | 35 |
| Sample 10 | | | 0.920 | 0.171 | 0 |

### Discussion

As can be understood from Table 1, the batteries including the vanadium oxides represented by the composition formula (1) as active materials have high discharge capacities.

As can be understood from comparison between Samples 1 to 8 and Sample 9, a high discharge capacity is confirmed when y is greater than 0 and 0.61 or less.

According to the results for Sample 6 and Sample 10, a discharge capacity is lost when y is too large. Since y is 0.610 in Sample 6 and 0.920 in Sample 10, the upper limit of y is thought to be around 0.7.

As can be understood from comparison between Samples 1 to 7 and Sample 8, a high discharge capacity is confirmed when a is smaller than 0.891.

As can be understood from comparison between Sample 6 and Sample 7, a higher discharge capacity is confirmed when a is greater than 0.

As described above, the vanadium oxide of the present disclosure is suitable for providing a battery having excellent charge and discharge characteristics.

### INDUSTRIAL APPLICABILITY

The vanadium oxide of the present disclosure is used as a battery material, such as a material of an all-solid-state lithium ion secondary battery.

What is claimed is:

1. A vanadium oxide represented by a composition formula (1) Li_{(3+x+α-y)}Fe_{y}V₍₁₋ₓ₎MₓO_{(4+(α/2)+y)}, where 0≤α<1.0, 0≤x<1.0, and 0<y<0.7 are satisfied and M is at least one element selected from the group consisting of a tetravalent metal element and a tetravalent metalloid element.

2. The vanadium oxide according to claim 1, wherein the M comprises Ti in the composition formula (1).

3. The vanadium oxide according to claim 1, wherein 0≤α<0.85 is satisfied in the composition formula (1).

4. The vanadium oxide according to claim 1, wherein 0<α<1.0 is satisfied in the composition formula (1).

5. The vanadium oxide according to claim 1, wherein 0.2≤α≤0.6 is satisfied in the composition formula (1).

6. The vanadium oxide according to claim 1, wherein 0<x<1.0 is satisfied in the composition formula (1).

7. The vanadium oxide according to claim 1, wherein 0<x≤0.1 is satisfied in the composition formula (1).

8. The vanadium oxide according to claim 1, wherein 0.183≤y≤0.61 is satisfied in the composition formula (1).

9. A battery comprising:
a positive electrode;
a negative electrode; and
an electrolyte layer disposed between the positive electrode and the negative electrode, wherein
the negative electrode comprises the vanadium oxide according to claim 1.

10. The battery according to claim 9, wherein the negative electrode further comprises a conductive additive.
